(19) United States
(12) Patent Application Publication
(10) Pub. No.: US 2026/0332433 A1
(43) Pub. Date: Oct. 22, 2026

(54) HARDWARE-ENFORCED CONTENT MODERATION SYSTEM WITH ATTESTED EXECUTION AND AUDIT CHAIN

(71) Applicant: George William Bickerstaff, III, Greenwich, CT (US)

(72) Inventor: George William Bickerstaff, III, Greenwich, CT (US)

(21) Appl. No.: 19/567,144

(22) Filed: Mar. 15, 2026

(51) Int. Cl. H04L 9/32

(52) U.S. Cl. CPC H04L 9/3263

(57) ABSTRACT

Conventional content moderation systems execute in operating-system memory accessible to administrators, making audit records insufficient as tamper-evident evidence and preventing independent verification of moderation decisions. The disclosed system executes all moderation logic inside hardware-enforced Trusted Execution Environments that physically isolate executing code from host software, tests each decision for demographic fairness using sampled demographic variants, and records every outcome in an append-only Audit Chain with hardware write-once semantics that no software layer can alter. A cross-vendor Attestation Bridge confirms deployment integrity across heterogeneous hardware platforms using threshold key derivation bound to enclave measurements. A Governance Output Interface delivers encrypted Moderation Provenance Tokens to read-only Regulator Verification Nodes for independent verification without content exposure. End-to-end latency is below 500 milliseconds, encrypted computation is reduced by 60 to 70 percent through selective application, and bias detection achieves 95 percent confidence via bounded probabilistic sampling.

### CROSS-REFERENCE TO RELATED APPLICATIONS

None.

### FIELD OF THE INVENTION

This disclosure relates to content moderation systems for digital platforms, healthcare networks, financial services, and government operations. More particularly, the disclosure relates to hardware-based mechanisms for executing moderation logic inside processor-enforced memory isolation environments with verifiable decision provenance and cross-vendor integrity attestation.

### BACKGROUND OF THE INVENTION

Existing content moderation systems operate in software environments accessible to administrators, hypervisors, and cloud operators. These systems classify content using machine learning models and policy rules, compute compliance scores, and store decision records in conventional databases. Because execution logic, model weights, and logs reside in the same operating-system memory accessible to privileged software, no hardware-level boundary separates moderation logic from the parties responsible for operating it.

Typical architectures consist of an ingestion pipeline, a classification engine, and a logging module, all running under the same administrative credentials. Policy configurations can be updated without version-controlled evidence, and log records are written by the same software process that produces the decisions. This shared-trust architecture allows silent substitution of logic, rollback of model versions, and deletion of log entries without leaving detectable evidence.

Industry responses including encrypted databases and access controls protect data at rest but leave the execution environment unprotected. When systems deploy across multiple cloud providers, no unified mechanism confirms that each deployment runs identical, unmodified code. Audit records signed by software keys managed by the same operators who control the system are legally insufficient as tamper-evident evidence.

Existing moderation systems execute policy evaluation and audit logging within software environments accessible to privileged administrators, preventing independent verification of moderation decisions. There therefore remains a need for systems and methods that provide hardware-anchored provenance and verifiable audit integrity for content moderation decisions without exposing evaluated content.

### SUMMARY OF THE INVENTION

The disclosed invention separates moderation execution from platform operators by executing moderation logic inside hardware-isolated Trusted Execution Environments and producing cryptographically verifiable moderation records across heterogeneous hardware platforms. Each moderation decision is executed inside a TEE that physically isolates code and data from the host OS, attested through a unified Attestation Bridge, recorded in an append-only Audit Chain with hardware write-once semantics, and delivered as a tamper-evident verifiable record. This architecture provides audit integrity enforced by hardware-based execution isolation, independent of the software layers that operate the system.

The system comprises five core modules operating in fixed sequential order: a Secure Content Ingestion Module that authenticates content and applies selective homomorphic encryption at the TEE boundary; a Policy Evaluation Engine that applies versioned, anti-rollback-protected governance policies and generates a Policy Compliance Score; a Fairness Verification Engine that tests decisions for demographic bias using sampled demographic variants and generates cryptographic proof certificates; a Compliance and Audit Engine that maintains a hardware write-once hash-linked Audit Chain; and a Governance Output Interface that delivers encrypted Moderation Provenance Tokens to read-only Regulator Verification Nodes for independent verification without content exposure. An Attestation Bridge operates across all modules, validating the hardware integrity of every deployed TEE instance.

The key advantages of the disclosed system include: a tamper-evident audit chain maintained in hardware-protected memory that no software can alter; independent fairness verification producing cryptographic proof of correct execution; independent verification by regulators without access to evaluated content; and measurable improvements in system integrity by executing moderation logic inside processor-enforced hardware rather than software-accessible memory. The system achieves end-to-end latency below 500 milliseconds, reduces encrypted computation by 60 to 70 percent, and achieves 95 percent confidence in bias detection. The invention is embodied as a system (claim 1), a method (claim 2), and a computer-readable medium (claim 3).

### BRIEF DESCRIPTION OF THE DRAWINGS

FIG. 1 is a system architecture overview showing the five core modules in sequential data flow order and the Attestation Bridge operating across all modules. Content enters at the Secure Content Ingestion Module and exits as encrypted records delivered to Regulator Verification Nodes.

FIG. 1A shows the TEE orchestration layer. The Attestation Bridge normalizes cross-vendor enclave measurements, derives threshold encryption keys, and issues a Unified Attestation Certificate confirming all deployed instances execute identical authorized code.

FIG. 1B shows the content ingestion module. Sub-components include source signature verification, selective encryption of privacy-sensitive scoring vectors, content classification by category, and TEE boundary enforcement.

FIG. 1C shows the policy evaluation module. Sub-components include the TEE-internal policy cache, monotonic counter verification, weighted compliance score computation, and decision routing.

FIG. 1D shows the fairness verification module. Sub-components include demographic sampling, counterfactual score comparison, violation detection, and cryptographic proof generation.

FIG. 1E shows the governance output interface. Sub-components include Moderation Provenance Token assembly, structured document formatting, and encrypted delivery to Regulator Verification Nodes.

FIG. 2 shows the Secure Content Ingestion Module in detail. Sub-components are the input pipeline (FIG. 2A), signature verification unit (FIG. 2B), selective encryption filter (FIG. 2C), content classification engine (FIG. 2D), and TEE boundary enforcement layer (FIG. 2E).

FIG. 2A shows the input pipeline receiving content from REST APIs, file uploads, and streaming feeds with format normalization.

FIG. 2B shows the signature verification unit checking source authenticity against TEE-stored credentials, with rejections logged to the Audit Chain.

FIG. 2C shows the selective encryption filter. Selective homomorphic encryption is applied to privacy-sensitive scoring vectors at the enclave entry point, reducing encrypted computation by 60 to 70 percent compared to full-content encryption, corresponding to the selective encryption limitation of claim 1 and claim 5.

FIG. 2D shows the classification engine assigning regulatory category and routing to the appropriate compliance pathway.

FIG. 2E shows the TEE boundary enforcement layer with enclave memory page allocation, processor-package encryption, and DMA access prevention.

FIG. 3 shows the Policy Evaluation Engine in detail. Sub-components are the policy retrieval module (FIG. 3A), cache manager (FIG. 3B), scoring engine (FIG. 3C), policy lineage tracker (FIG. 3D), and decision router (FIG. 3E).

FIG. 3A shows the policy retrieval module verifying the Policy State's signature and monotonic counter before evaluation begins.

FIG. 3B shows the cache manager storing the active Policy State in enclave memory and invalidating it when a higher-counter State arrives.

FIG. 3C shows the scoring engine computing the weighted compliance score deterministically from validated policy criteria.

FIG. 3D shows the policy lineage tracker hash-chaining successive Policy States into a traversable record of all policy changes.

FIG. 3E shows the decision router directing items scoring below the routing threshold to the human oversight queue.

FIG. 4 shows the Fairness Verification Engine in detail. Sub-components are the counterfactual generator (FIG. 4A), demographic sampling module (FIG. 4B), bias detection module (FIG. 4C), proof generator (FIG. 4D), and Moderation Provenance Token assembly (FIG. 4E).

FIG. 4A shows the counterfactual generator substituting demographic attributes using precomputed embeddings while preserving semantic content.

FIG. 4B shows the demographic sampling module selecting four to eight sampled demographic variants probabilistically from a bounded substitution set.

FIG. 4C shows the bias detection module computing compliance score differentials and flagging violations exceeding the configurable tolerance.

FIG. 4D shows the proof generator producing a cryptographic proof of correct execution without disclosing protected model internals or attributes.

FIG. 4E shows the Moderation Provenance Token assembly encoding provenance data into a TEE-signed structure attached to each decision record.

FIG. 5 shows the Compliance and Audit Engine in detail. Sub-components are the Audit Chain storage (FIG. 5A), monotonic counter enforcer (FIG. 5B), compliance monitor (FIG. 5C), package generator (FIG. 5D), and anomaly detector (FIG. 5E).

FIG. 5A shows the Audit Chain storage system maintaining append-only records in hardware write-once enclave memory with hash-linking between successive records.

FIG. 5B shows the monotonic counter enforcer incrementing on authorized updates, binding to firmware measurements, and logging rollback attempts.

FIG. 5C shows the compliance monitor tracking adherence status and writing per-record compliance indicators.

FIG. 5D shows the package generator assembling signed Compliance Attestation Packages from accumulated records, lineage data, and proof references.

FIG. 5E shows the anomaly detector monitoring override frequency and temporal patterns, writing signed alerts when thresholds are exceeded.

### DETAILED DESCRIPTION OF THE INVENTION

### Definitions

The following terms are defined for clarity and interpretation of the claims. Additional terms may be defined throughout the specification where appropriate.
1. “Attestation Bridge” means a component that verifies Trusted Execution Environment attestations from multiple hardware platforms against their respective Hardware Root of Trust certificate chains and confirms that identical authorized code is executing across all deployed instances. It derives shared encryption keys using a threshold scheme that binds each key share to one enclave's hardware measurement.
2. “Audit Chain” means an append-only sequence of Structured Moderation Records stored in hardware write-once TEE-protected memory, in which each record contains the cryptographic hash of the immediately preceding record, such that any modification, insertion, or deletion is immediately detectable.
3. “Compliance Attestation Package” means a TEE-signed bundle of Structured Moderation Records, Policy Lineage Records, fairness summaries, proof certificate references, logged attack events, and a Software Bill of Materials, formatted for delivery to authorized recipients.
4. “Hardware Root of Trust” means the cryptographic chain of trust anchored to a TEE processor manufacturer's root certificate, establishing that all signed attestations originate from a genuine, unmodified enclave on verified hardware.
5. “Moderation Provenance Token” means a compact TEE-signed data structure encoding the content identifier, active Policy State hash, model version hash, enclave measurement, and hardware-attested timestamp, enabling any recipient to verify the chain of custody for a moderation decision without accessing evaluated content.
6. “Policy Compliance Score” means a scalar value in [0.0, 1.0] computed deterministically inside the TEE as the weighted sum of individual criterion scores using coefficients validated against manipulation-prevention bounds at policy activation time.
7. “Policy State” means a TEE-protected, sequentially versioned record comprising the hash of the authorized governance policy content, the hash of the immediately preceding Policy State, an authorized digital signature, a hardware-enforced monotonic counter value, and a hardware-attested timestamp, forming a hash-chained Policy Lineage Record.
8. “Trusted Execution Environment (TEE)” means a hardware-enforced, processor-isolated execution zone in which code and data are protected from access or modification by the host operating system, hypervisor, or any privileged software layer, implemented through enclave-protected memory page allocation, automatic processor-package memory encryption, and hardware attestation via the manufacturer's Hardware Root of Trust.
9. “Structured Moderation Record” means a TEE-signed record of a single moderation event comprising a content identifier, Policy Compliance Score, Moderation Provenance Token, proof certificate reference, compliance status indicators, moderation decision, hardware-attested timestamp, hash of the preceding Audit Chain entry, and a TEE-generated digital signature.
10. “Zero-Knowledge Proof Certificate” means a succinct non-interactive cryptographic proof generated within the TEE or by a separately attested proof service, proving that the registered AI model was used and the evaluation protocol was followed, without disclosing model weights, intermediate values, evaluated content, or protected attributes.

### System Architecture

The system executes all moderation operations inside processor-enforced Trusted Execution Environments. A TEE provides three hardware-level isolation properties: (a) the processor allocates enclave-protected memory pages that the host OS, hypervisor, and DMA-capable peripherals cannot access; (b) all enclave memory is automatically encrypted when leaving the processor package using a hardware-managed key unavailable to software; and (c) the processor attests the initial enclave state through the Hardware Root of Trust. These mechanisms are enforced at the silicon level. By enforcing execution and audit generation inside processor-enforced memory isolation environments, the system improves the security and integrity of computer systems that perform automated content moderation. Unlike conventional moderation systems that execute entirely in software environments accessible to administrators, the disclosed system executes moderation evaluation and audit generation inside processor-enforced Trusted Execution Environments where no privileged software layer can access executing code or audit records. Execution within TEE-protected memory eliminates the silent logic substitution possible in software-only environments, where the operating system or hypervisor retains ultimate memory access.

### System Pipeline

Processing proceeds in the following fixed order within the TEE boundary: (1) content reception and source authentication; (2) selective encryption of sensitive attributes and regulatory classification; (3) policy evaluation and compliance scoring; (4) fairness verification using sampled demographic variants; (5) human oversight when the compliance score falls below the routing threshold; (6) tamper-evident audit record creation; and (7) delivery of signed, verifiable records to authorized recipients.

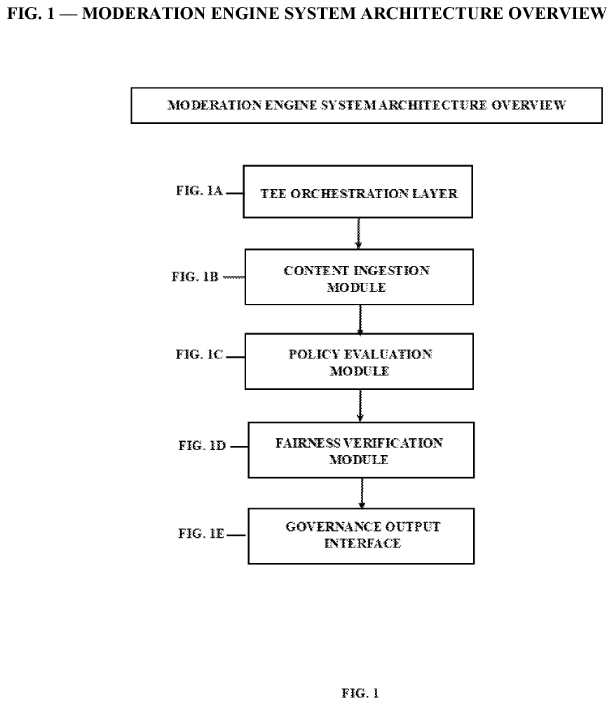

The architecture comprises five modules shown in FIG. 1: the Secure Content Ingestion Module, Policy Evaluation Engine, Fairness Verification Engine, Compliance and Audit Engine, and Governance Output Interface. An Attestation Bridge operates across all modules, validating each deployed TEE instance. In some embodiments, each module runs as a microservice within a secure enclave runtime library such as Open Enclave SDK or Gramine, with message queues between modules providing asynchronous handoff without exposing content outside the TEE boundary.

The system supports heterogeneous TEE deployment across Intel SGX, AMD SEV-SNP, ARM TrustZone, Intel TDX, AWS Nitro Enclaves, Google Confidential VMs, Azure Confidential VMs, and any future processor architecture providing equivalent enclave memory encryption and remote attestation. In the preferred implementation, the system deploys primarily on Intel TDX enclaves with AWS Nitro Enclaves as secondary nodes, utilizing GPU offload for homomorphic encryption operations and Groth16 zk-SNARKs for fairness proofs. In alternative embodiments, BLAKE3 hashing replaces SHA-3-512 in the Audit Chain for faster verification while maintaining equivalent collision resistance. Optionally, the monotonic counter fuses hardware and firmware registers for added tamper resistance in high-security deployments.

In some embodiments, the system uses post-quantum digital signatures and post-quantum key encapsulation for output encryption; in other embodiments, classical digital signatures and standard encrypted transport are used where post-quantum resistance is not required.

In a large-scale deployment processing 10 million decisions per day, the system distributes evaluation across 200 TEE instances deployed as a cluster of hardware-secured compute nodes within cloud infrastructure. Each node executes moderation logic inside a TEE and transmits signed moderation records to independent Regulator Verification Nodes. The Attestation Bridge verifies each cluster node's enclave measurement before accepting its results, and the (t, N) threshold key scheme ensures compromise of any single node does not expose the policy encryption key.

### Threat Model

The system resists four adversarial actor categories. System administrators with OS credentials cannot access enclave memory because TEE hardware enforces page isolation independently of OS privilege. Cloud operators cannot observe executing code because processor-package encryption renders enclave contents opaque. Malicious actors attempting to substitute unauthorized model versions are blocked by the hardware-anchored monotonic counter, which rejects any candidate version bearing a lower counter value and cannot be decremented by software. External attackers injecting unsigned content are blocked by source signature verification at the TEE boundary before any content enters the TEE.

### Secure Content Ingestion Module

The Secure Content Ingestion Module is the TEE boundary gateway. It accepts content from REST API endpoints, file uploads, and streaming data feeds. It verifies each item's source digital signature against a registered credential stored in TEE-protected memory and rejects unsigned content before TEE entry, logging each rejection event.

The Module applies selective encryption to privacy-sensitive scoring vectors—specifically demographic-attribute feature vectors and regulated personal data fields—while processing non-sensitive features in TEE plaintext. This reduces encrypted computation by 60 to 70 percent compared to full-content encryption, achieving ingestion latency of 20 to 40 milliseconds. Each item is then classified by regulatory category for downstream routing.

In some embodiments, source authentication uses post-quantum digital signatures; in alternative embodiments, classical ECDSA signatures are used where post-quantum resistance is not required. In some embodiments, GPU-accelerated polynomial arithmetic reduces encryption time by a factor of three to five while maintaining all computation within the TEE; in alternative embodiments, a different lattice-based encryption scheme is used for exact integer arithmetic. In some deployments, routing directs content to compliance pathways supporting regulatory frameworks such as healthcare, financial services, or AI governance requirements; these frameworks are referenced as deployment contexts and do not define the inventive concept.

### Policy Evaluation Engine

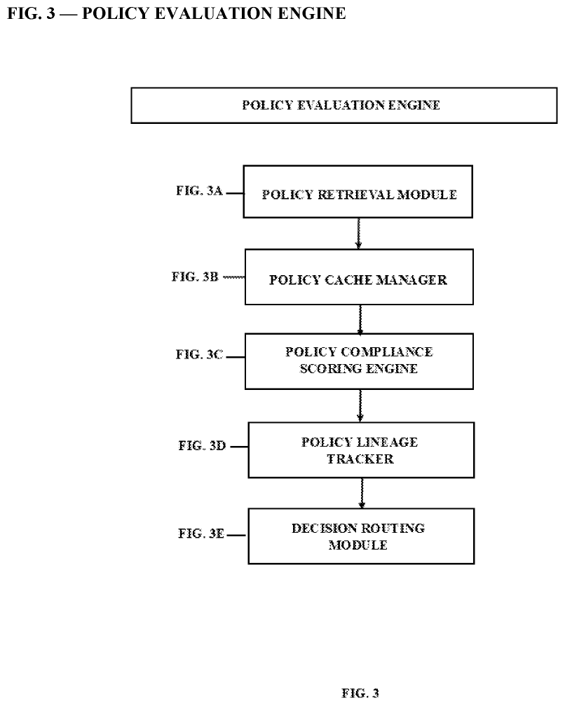

The Policy Evaluation Engine applies the active governance policy to content and produces a Policy Compliance Score. It retrieves the active Policy State from a TEE-internal policy cache (shown in FIG. 3B), verifies its digital signature and hardware-enforced monotonic counter value (shown in FIG. 3A), computes the compliance score as the deterministic weighted sum of criterion scores using coefficients validated against manipulation-prevention bounds (shown in FIG. 3C), and maintains a hash-chained Policy Lineage Record (shown in FIG. 3D). The cache reduces Policy State retrieval latency from approximately 8 milliseconds to under 0.5 milliseconds on a cache hit. Any attempt to activate a Policy State bearing a lower counter value is rejected and logged as a signed attack event.

Each Policy State comprises the hash of the policy content, the hash of the immediately preceding State, an authorized digital signature, a hardware-enforced monotonic counter value, and a hardware-attested timestamp. In some embodiments, the monotonic counter is a fused hardware-firmware register bound to TPM Platform Configuration Register values; firmware substitution produces a counter inconsistency detectable at the Attestation Bridge. In alternative embodiments, the monotonic counter is implemented using a dedicated hardware security module counter register that persists counter state across power cycles independently of the TEE platform. Items scoring below the routing threshold are forwarded to the Human Oversight Interface before the Audit Chain record is written. In alternative embodiments, the routing threshold adjusts dynamically based on measured accuracy feedback from previously reviewed decisions.

### Fairness Verification Engine

The Fairness Verification Engine tests each decision for demographic bias using a computationally bounded counterfactual approach. It maintains a precomputed demographic embedding library—a fixed set of feature vectors for protected-attribute categories including race, gender, age, and national origin—enabling substitution generation in under 5 milliseconds per variant. In some embodiments, the library includes intersectional attribute combinations; in alternative embodiments, a simplified two-category substitution set is used when computational resources are constrained.

For each evaluation, the Engine probabilistically samples four to eight sampled demographic variants from the bounded substitution set and evaluates each through the same policy criteria. This sampling depth achieves 95 percent confidence in bias detection at threshold 0.12—representing the maximum allowable compliance score differential between demographic variants—with evaluation latency of 40 to 60 milliseconds. The evaluation procedure is as follows: (1) evaluate the original content item under the active policy to obtain a baseline compliance score; (2) evaluate each sampled demographic variant under the same policy; and (3) if any variant score differs from the baseline by more than the configurable threshold, flag a fairness violation and route the item to enhanced review.

If any variant's compliance score differs from the original by more than the configurable threshold, the Engine records a fairness violation and routes the item for enhanced human review. After evaluation, the Engine generates a Zero-Knowledge Proof Certificate attesting correct model execution and fairness protocol compliance without disclosing model weights or protected attributes. In some embodiments, one of several available cryptographic proof systems is selected based on proof size or trusted-setup requirements; for example, Groth16 provides shorter proofs while PLONK eliminates per-circuit trusted setup. In alternative embodiments, the fairness test uses a fixed substitution set rather than probabilistic sampling when deterministic results are required. Proofs are generated periodically, for sampled decisions, or by a separately attested proof service to avoid per-decision latency impact. The Engine then assembles a Moderation Provenance Token encoding the content identifier, Policy State hash, model version hash, enclave measurement, and hardware-attested timestamp.

### Compliance and Audit Engine

The Compliance and Audit Engine records every moderation outcome and monitors compliance status. The Audit Chain is stored in TEE-protected enclave memory with hardware write-once semantics: once committed, the processor configures that region as read-only and rejects subsequent write operations. Each record is cryptographically hash-linked to its predecessor; any modification produces a detectable chain break. This hardware-enforced structure prevents undetected modification of audit records, in contrast to conventional software logging where privileged processes can alter or delete entries without cryptographic detection. Unlike conventional cross-vendor deployments that rely on software consistency checks, the Attestation Bridge cryptographically confirms identical code execution by binding attestation to hardware-measured enclave state. In alternative embodiments, the Audit Chain is replicated to an append-only database outside the TEE; in this case, the TEE-signed hash chain remains the authoritative record and the replicated copy serves read-only query access.

The hardware-anchored monotonic counter increments on each model or policy update and cannot be decremented by software. Rollback attempts are logged as signed attack events. Optionally, the counter binds to TPM firmware measurements for additional tamper resistance. The Engine monitors override activity for anomalies including unusual override frequency per reviewer and temporal clustering of overrides using a sliding-window algorithm; anomalies are logged as signed alerts. In some embodiments, the compliance status tracking supports deployment frameworks requiring continuous audit evidence; in these cases, the Engine generates Compliance Attestation Packages at configurable intervals, bundling records, lineage data, fairness summaries, attack logs, and a Software Bill of Materials under a TEE digital signature.

### Governance Output Interface

The Governance Output Interface formats Structured Moderation Records as signed structured documents with embedded Moderation Provenance Tokens and hardware-attested timestamps. It establishes encrypted, mutually authenticated channels to read-only Regulator Verification Nodes that independently verify record signatures, Audit Chain integrity, Policy State sequencing, and proof correctness without receiving evaluated content. Delivery is one-directional; Nodes cannot modify Engine state. In certain implementations, during temporary network isolation from the Attestation Bridge, the system operates in local attestation mode using a cached Unified Attestation Certificate valid for up to 24 hours, after which processing halts until re-attestation succeeds. In alternative embodiments, the Attestation Bridge uses a hierarchical attestation architecture in which regional attestation proxies issue short-lived sub-certificates, reducing attestation latency in geographically distributed deployments.

### Attestation Bridge and Failure Recovery

The Attestation Bridge validates vendor attestation formats at startup and on each restart, normalizes enclave measurements, and uses threshold key derivation in which each key share is bound to one enclave's measurement value, with at least t shares required for reconstruction. Compromise of fewer than t instances does not expose the policy encryption key. Upon enclave restart, the Engine performs full re-attestation before accepting content, recovers the Audit Chain from sealed storage using a sealing key bound to the enclave measurement, verifies hash-chain integrity, excludes pre-crash partial records, and rejects any stale Policy State or model version bearing a lower counter value.

In some embodiments, when TEE hardware is unavailable, the Engine operates in a Multi-Party Computation fallback mode distributing policy evaluation across at least three independent nodes under a threshold signature scheme with Policy State replicated via consensus protocol. In alternative embodiments, a trusted hardware security module provides audit signing without full execution isolation; this mode is disclosed as a minimum fallback providing audit tamper-evidence but not complete execution isolation. In certain implementations, a hybrid architecture combines a Trusted Execution Environment for policy evaluation and compliance scoring with a dedicated hardware security module for cryptographic signing and key storage, such that the TEE handles computation-intensive moderation logic while the HSM provides FIPS 140-3 certified key operations; this hybrid mode is supported on platforms where TEE and HSM coexist and adds an independent hardware security boundary around key material even if the TEE is compromised.

### Latency Budget

Content ingestion takes 20 to 40 milliseconds; policy evaluation approximately 10 to 30 milliseconds; fairness sampling 40 to 60 milliseconds; audit logging under 10 milliseconds; and output formatting approximately 15 milliseconds. Zero-Knowledge Proof generation is asynchronous and does not contribute to per-decision latency. Total synchronous path: 85 to 155 milliseconds typical; maximum observed: 450 milliseconds.

### Deployment Note

The system may be deployed as a cluster of hardware-secured compute nodes operating within cloud infrastructure, with each node executing moderation logic inside a Trusted Execution Environment and transmitting signed moderation records to independent Regulator Verification Nodes. In some deployments, the audit database may be replicated across multiple cloud regions for resilience, with the TEE-signed hash chain serving as the authoritative tamper-evident record.

The foregoing description is illustrative. The scope of protection is defined by the appended claims.

### DESCRIPTION OF THE DRAWINGS

FIG. 1 illustrates the system architecture overview with all five modules, the Attestation Bridge, and Regulator Verification Nodes. Every element of independent claims 1, 2, and 3 is represented in this figure. FIG. 1 may also represent a distributed cluster deployment where each module executes as a separate enclave service communicating via encrypted message queues, with the Attestation Bridge operating as a shared attestation coordinator across all nodes.

FIG. 1A shows the Attestation Bridge normalizing cross-vendor measurements and issuing the Unified Attestation Certificate, corresponding to the Attestation Bridge described in claim 3.

FIG. 1B shows the Secure Content Ingestion Module with signature verification, selective encryption, classification, and TEE boundary enforcement, corresponding to the content ingestion module described herein.

FIG. 1C shows the Policy Evaluation Engine with policy cache, counter verification, scoring, and decision routing, corresponding to the policy evaluation engine described herein.

FIG. 1D shows the Fairness Verification Engine with demographic sampling, counterfactual comparison, violation detection, and proof generation, corresponding to the fairness verification engine described herein.

FIG. 1E shows the Governance Output Interface with Moderation Provenance Token assembly and encrypted Regulator Verification Node delivery, corresponding to the governance output interface described herein.

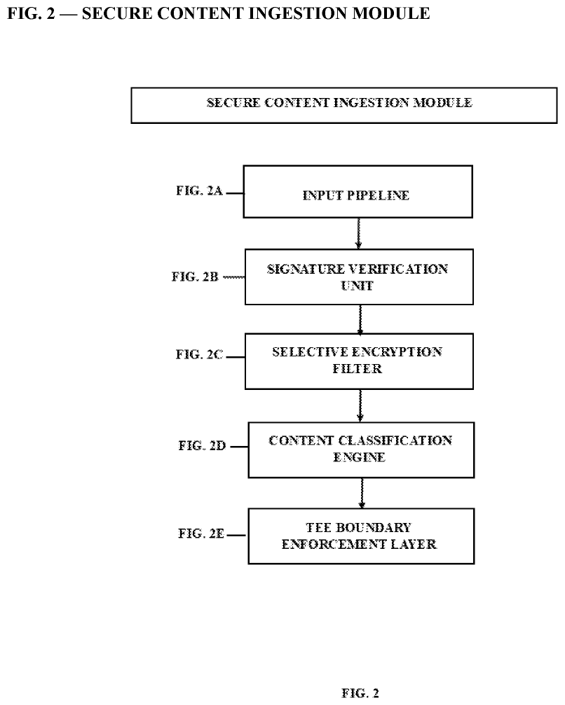

FIG. 2 illustrates the Secure Content Ingestion Module in detail. Every element of the content ingestion limitation of claim 1 appears in FIGS. 2A through 2E.

FIG. 2A shows the input pipeline. FIG. 2B shows the signature verification unit logging rejections to the Audit Chain of claim 1. FIG. 2C shows the selective encryption filter, satisfying the 60 to 70 percent surface reduction of claim 5. FIG. 2D shows the classification engine routing to specialized pathways. FIG. 2E shows the TEE boundary enforcement layer satisfying the hardware isolation of claim 1.

FIG. 3 illustrates the Policy Evaluation Engine in detail. Every element of the policy evaluation limitation of claim 1 appears in FIGS. 3A through 3E.

FIG. 3A shows the policy retrieval module. FIG. 3B shows the cache manager. FIG. 3C shows the scoring engine. FIG. 3D shows the Policy Lineage Tracker satisfying the hash-linked lineage of claim 1. FIG. 3E shows the decision router satisfying the routing threshold of claim 9.

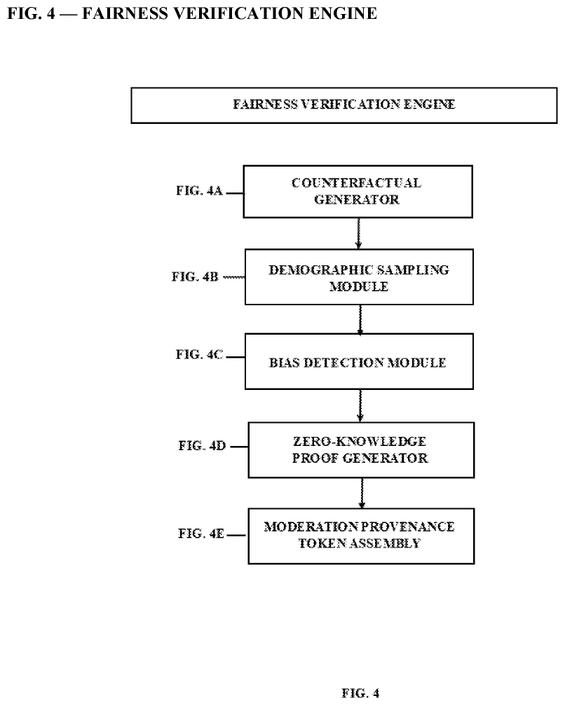

FIG. 4 illustrates the Fairness Verification Engine in detail. Every element of the fairness verification limitation of claim 1 appears in FIGS. 4A through 4E.

FIG. 4A shows the counterfactual generator. FIG. 4B shows the demographic sampling module satisfying the sampled demographic variants limitation of claims 1 and 8. FIG. 4C shows the bias detection module satisfying the violation detection limitation of claim 1. FIG. 4D shows the proof generator satisfying the proof certificate limitation of claims 1 and 9. FIG. 4E shows the Moderation Provenance Token assembly.

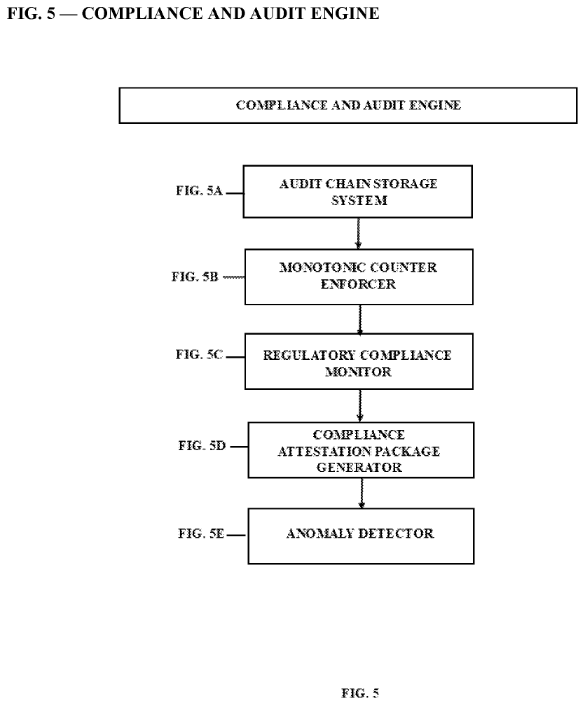

FIG. 5 illustrates the Compliance and Audit Engine in detail. Every element of the audit logging limitation of claim 1 appears in FIGS. 5A through 5E.

FIG. 5A shows the append-only Audit Chain of claim 1, which enforces hardware write-once semantics via TEE-protected memory allocation with committed regions configured read-only at the processor level, corresponding to the Audit Chain limitation of claims 1 and 6. FIG. 5B shows the hardware-anchored monotonic counter bound to platform firmware measurements via TPM PCR values, corresponding to the rollback protection limitation of claims 1 and 7. FIG. 5C shows the compliance monitor corresponding to the regulatory monitoring of claim 1. FIG. 5D shows the package generator corresponding to claim 13. FIG. 5E shows the anomaly detector corresponding to claim 12.

### ENABLEMENT EXAMPLES

### Example 1—Preferred Commercial Implementation

Input: A regulated financial communication enters via REST API with a valid source signature. The Secure Content Ingestion Module verifies the signature, selectively encrypts demographic scoring vectors, and classifies the item for the financial compliance pathway.
Processing: The Policy Evaluation Engine retrieves the active Policy State from cache (0.4 ms) and computes Policy Compliance Score=0.92. The Fairness Verification Engine draws six sampled demographic variants; the maximum score differential is 0.09, below the 0.12 threshold, confirming no bias. A Zero-Knowledge Proof Certificate reference is attached to the decision record.
Decision and Audit: The Compliance and Audit Engine appends the Structured Moderation Record with Moderation Provenance Token to the Audit Chain and verifies hash-chain integrity across 47 prior records.
Output Verification: The Governance Output Interface delivers an encrypted signed document to the designated Regulator Verification Node, which independently verifies the record signature and Audit Chain integrity without receiving the evaluated content. End-to-end latency: 320 milliseconds. This implementation uses commercially available Intel SGX hardware.

### Example 2—Alternative System Configuration

Input: A healthcare imaging report enters an AMD SEV-SNP TEE deployment. The Attestation Bridge validates the AMD attestation report and issues a Unified Attestation Certificate. The Secure Content Ingestion Module verifies the source signature, applies GPU-accelerated selective encryption, and classifies the item as medical software high-risk.
Processing: The Policy Evaluation Engine computes Policy Compliance Score=0.65, below the 0.70 routing threshold. The Fairness Verification Engine draws four sampled demographic variants; no differentials exceed 0.15. The item routes to the Human Oversight Interface; a certified reviewer's credentials are verified within the TEE and an override decision is issued.
Decision and Audit: The Compliance and Audit Engine writes the override decision, reviewer identity, and justification code to the Audit Chain.
Output Verification: The Governance Output Interface packages the record into a Compliance Attestation Package for delivery. End-to-end automated latency: 410 milliseconds. This configuration uses commercially available AMD EPYC processors with SEV-SNP support.

### Example 3—Edge-case or Failure-handling Scenario

Input: A post flagged as potential misinformation enters the system while an adversary attempts to activate a model version with counter value 6 against the current hardware counter value 7.
Processing: The monotonic counter enforcer rejects the activation and writes a signed rollback attack event to the Audit Chain. The Policy Evaluation Engine computes Policy Compliance Score=0.45. The Fairness Verification Engine draws eight sampled demographic variants with maximum differential 0.05, confirming no bias.
Decision and Audit: The Compliance and Audit Engine appends the decision record. Following a scheduled restart, the Engine re-attests, recovers the Audit Chain with all 312 prior records intact, and rejects a stale Policy State at counter value 5.
Output Verification: The Governance Output Interface delivers the signed record with Moderation Provenance Token. End-to-end content latency: 450 milliseconds.

What is claimed is:

1. A hardware-enforced content moderation system comprising:
(a) one or more processors executing within a Trusted Execution Environment that physically isolates executing code and data from the host operating system and peripheral devices, and cryptographically attests the initial execution state via a Hardware Root of Trust;
(b) a Secure Content Ingestion Module executing within the Trusted Execution Environment and configured to authenticate incoming content, apply selective encryption to privacy-sensitive scoring vectors, and classify content by applicable category;
(c) a Policy Evaluation Engine executing within the Trusted Execution Environment and configured to apply a versioned moderation policy, enforce anti-rollback protection using a hardware-anchored monotonic counter, and generate a Policy Compliance Score;
(d) a Fairness Verification Engine executing within the Trusted Execution Environment and configured to test moderation outcomes for demographic bias using sampled demographic variants and generate cryptographic proof certificates verifying execution correctness;
(e) a Compliance and Audit Engine executing within the Trusted Execution Environment and configured to maintain an append-only hash-linked Audit Chain in hardware write-once enclave memory; and
(f) a Governance Output Interface configured to assemble verifiable records of moderation decisions and deliver encrypted records to read-only verification endpoints for independent verification without content disclosure.

2. A computer-implemented method for hardware-enforced content moderation, the method executed within a Trusted Execution Environment and comprising:
(a) authenticating incoming content and rejecting unauthenticated content before processing within the Trusted Execution Environment;
(b) applying selective encryption to privacy-sensitive scoring vectors at the enclave boundary while processing non-sensitive features in Trusted Execution Environment plaintext;
(c) retrieving a versioned moderation policy from a hardware-protected cache, enforcing anti-rollback protection using a hardware-anchored monotonic counter, and computing a Policy Compliance Score;
(d) testing each moderation decision for demographic bias by evaluating sampled demographic variants and generating or referencing cryptographic proof certificates;
(e) recording each outcome in an append-only hash-linked Audit Chain in hardware write-once Trusted Execution Environment memory; and
(f) delivering signed, encrypted decision records to read-only verification endpoints via mutually authenticated channels.

3. A non-transitory computer-readable medium storing instructions that, when executed within a Trusted Execution Environment supporting heterogeneous hardware platforms, cause processors to perform the method of claim 2, wherein the instructions further cause the processors to operate an Attestation Bridge that validates attestation reports from multiple hardware vendors against their Hardware Root of Trust certificate chains, derives shared encryption keys using a threshold scheme binding each key share to one enclave's hardware measurement, and produces a Unified Attestation Certificate confirming all deployed instances execute identical authorized code; and wherein, upon enclave restart, the processors re-attest all instances before accepting content, recover the Audit Chain from sealed storage using a measurement-bound sealing key, and reject any policy or model version bearing a monotonic counter value lower than the post-recovery hardware counter.

4. The system of claim 1, wherein the Trusted Execution Environment supports heterogeneous hardware implementations from multiple vendors, and wherein an Attestation Bridge validates each vendor's attestation format against its Hardware Root of Trust certificate chain and produces a Unified Attestation Certificate enabling single-operation verification across all deployments.

5. The system of claim 1, wherein the Secure Content Ingestion Module applies homomorphic encryption selectively to demographic-attribute scoring vectors and regulated personal data fields, reducing the encrypted computation surface by 60 to 70 percent compared to full-content encryption and achieving ingestion latency of 20 to 40 milliseconds per item.

6. The system of claim 1, wherein the Compliance and Audit Engine uses cryptographic hash-linking for the Audit Chain and enforces hardware write-once semantics by configuring committed enclave memory regions as read-only at the processor level, and further verifies the hash of the active policy content before each evaluation and halts processing upon any mismatch.

7. The system of claim 1, wherein the hardware-anchored monotonic counter is bound to platform firmware measurement values via TPM Platform Configuration Register values such that any firmware substitution produces a detectable inconsistency, and wherein rejected rollback attempts are recorded in the Audit Chain as signed attack events comprising the rejected version identifier and current counter value.

8. The system of claim 1, wherein the Fairness Verification Engine probabilistically samples four to eight sampled demographic variants per evaluation from a bounded substitution set using precomputed embeddings, achieving 95 percent confidence in bias detection at tolerance threshold 0.12 with fairness evaluation latency of 40 to 60 milliseconds per decision.

9. The system of claim 1, wherein the Policy Evaluation Engine routes items scoring below the configurable Policy Compliance Score threshold to a Human Oversight Interface presenting per-criterion score contributions and fairness differentials, accepts override actions only from reviewers whose credentials and current training certification have been verified within the Trusted Execution Environment, and permanently records all overrides in the Audit Chain.

10. The method of claim 2, further comprising operating the Attestation Bridge using a (t, N) threshold key derivation scheme in which a shared policy encryption key is split into N shares each bound to one enclave's measurement value, requiring at least t matching-measurement enclaves for key reconstruction, with non-matching enclaves rejected and logged.

11. The method of claim 2, wherein source authentication uses cryptographic digital signatures verified against credentials stored in the Trusted Execution Environment, and wherein the selective encryption applies homomorphic techniques permitting evaluation of privacy-sensitive attributes without decryption outside the Trusted Execution Environment boundary.

12. The method of claim 2, wherein the Compliance and Audit Engine monitors override frequency per reviewer and temporal clustering of override events using a sliding-window algorithm and records a signed anomaly event in the Audit Chain and routes an alert to administrators when configurable thresholds are exceeded.

13. The method of claim 2, further comprising generating Compliance Attestation Packages at configurable intervals comprising all Structured Moderation Records, Policy Lineage Records, fairness aggregate statistics, proof certificate references, logged attack events, and a Software Bill of Materials, all covered by a digital signature generated within the Trusted Execution Environment.

14. The method of claim 2, further comprising, when Trusted Execution Environment hardware is unavailable, distributing policy evaluation across at least three independent nodes under a threshold signature scheme requiring a minimum quorum to produce a valid evaluation signature, with policy state replicated across nodes and sequence numbers enforcing anti-rollback guarantees.

15. The method of claim 2, further comprising dynamically adjusting the Policy Compliance Score routing threshold for human oversight based on measured accuracy feedback from previously reviewed decisions in the same content category, tightening automatically when accuracy falls below a configurable minimum.

16. The system of claim 1, wherein the Policy Evaluation Engine applies GPU-accelerated polynomial arithmetic for homomorphic encryption operations within the Trusted Execution Environment, reducing encryption evaluation time by a factor of three to five compared to CPU-only execution while maintaining all computation within the hardware-isolated boundary.

17. The system of claim 1, wherein the Secure Content Ingestion Module classifies content into healthcare, financial services, medical software, and artificial intelligence governance categories and routes each to a specialized compliance pathway within the Compliance and Audit Engine.

18. The system of claim 1, wherein the Governance Output Interface formats Structured Moderation Records as JSON-LD documents with embedded digital signatures and hardware-attested timestamps, with context declarations linking fields to standardized ontologies for automated compliance tool consumption.

19. The system of claim 1, wherein the Compliance and Audit Engine maintains a continuously updated Software Bill of Materials comprising identifiers, version numbers, and cryptographic hashes of all deployed software components, AI models, and dependency libraries, generating a new signed record upon each component change.

20. The system of claim 1, wherein the Zero-Knowledge Proof Certificates generated by the Fairness Verification Engine are additionally usable by the Governance Output Interface to demonstrate to authorized recipients that the AI model executed with the registered version hash produced outputs consistent with the claimed fairness evaluation without requiring disclosure of model internals.
